(19) United States
(12) Patent Application Publication
(10) Pub. No.: US 2011/0227242 A1
(43) Pub. Date: Sep. 22, 2011

(54) FASTENING EQUIPMENT FOR AN ELEVATOR INSTALLATION

(76) Inventors: Agnaldo Santos, Sao Paulo (BR); Eduardo Felipeli, Taboao da Serra (BR)

(21) Appl. No.: 13/051,335

(22) Filed: Mar. 18, 2011

(30) Foreign Application Priority Data
Mar. 18, 2010 (EP) 10156850.9

(51) Int. Cl. B28B 7/02

(52) U.S. Cl. 264/39; 425/186

(57) ABSTRACT

Fastening equipment for an elevation installation comprises a shuttering element that can be attached to an elevator shaft wall and to an elevator guide rail. The shuttering element has walls that at least partially define a receiving region for hardenable casting material.

### CROSS-REFERENCE TO RELATED APPLICATION

This application claims priority to European Patent Application No. 10156850.9, filed Mar. 18, 2010, which is incorporated herein by reference.

### FIELD

The present disclosure relates to fastening equipment for use in an elevator installation.

### BACKGROUND

An elevator installation usually comprises an elevator cage and a counterweight, which are moved in an elevator shaft in opposite directions. The elevator cage and the counterweight in that regard run in or along corresponding guide rails. The guide rails are typically formed from profile members, which are joined together in vertical alignment in the elevator shaft.

A guide rail typically has a T-shaped profile, comprising a base and a web, which is mounted centrally on the base and which extends inwardly in the direction of the elevator cage or the counterweight unit. The corresponding rail profile members have in the past been fastened to the shaft wall by constructionally complicated elements.

An example of corresponding fastening means can be inferred from the patent application DE 101 26 833 B4. In this connection, reference is made, for example, to FIG. 2 of this patent specification.

It is a disadvantage of the known fastening means that they are constructionally complicated. Moreover, problems arise with absorption and dissipation of force in the case of alternate loading and individual elements can loosen in the long term and thus place the functional capability of the entire equipment at risk.

### SUMMARY

Technologies disclosed herein provide improved fastening equipment for use in an elevator installation, in order to avoid the disadvantages of previously known solutions, for example. At least some embodiments are concerned with a simple, robust and permanent fastening of T-shaped guide rails.

Some embodiments provide universally usable fastening equipment, which can be employed in different types of elevators and for different T-shaped guide rails.

Further embodiments can provide a correspondingly equipped elevator installation, which is furnished with at least one robust and permanent fastening device. Particular embodiments are also concerned with provision of a suitable method. Some embodiments allow for the improvement of the installation and alignment of the guide rails used in elevator systems. Moreover, the fastening can be economic, permanent and robust.

### BRIEF DESCRIPTION OF THE DRAWINGS

The disclosed technologies will be explained in more detail symbolically and by way of example on the basis of the figures. The figures are described conjunctively and in general.

In that case:

FIG. 1A shows a perspective illustration of a section of an elevator installation with elements of a first assembly set in an exploded illustration;

FIG. 1B shows a schematic plan view of a sheet metal body of the first shuttering element;

FIG. 2A shows a perspective illustration of a second of an elevator installation with second fastening equipment in an exploded illustrated;

FIG. 2B shows a schematic plan view of sheet metal body of the second shuttering element;

FIG. 2C shows a schematic plan view of a sheet metal body of the insert element;

FIG. 2D shows a perspective illustration of a section of an elevator installation with the second fastening equipment at the time of filling with a casting material;

FIG. 2E shows a perspective illustration of a section of an elevator installation with a fastening block, by way of example;

FIG. 3 shows a schematic illustration of the elements of a first assembly set; and

FIG. 4 shows a schematic illustration of the elements of a second assembly set.

### DETAILED DESCRIPTION

The following applies in general to the drawings and the further description:
The figures are to be considered as true to scale, even when individual aspects are illustrated in simplified or schematic form.
Constructional elements which are the same or similar or function in the same or similar manner are provided in all figures with the same reference numerals.
Statements such as right, left, above and below relate to the respective arrangement in the figures.

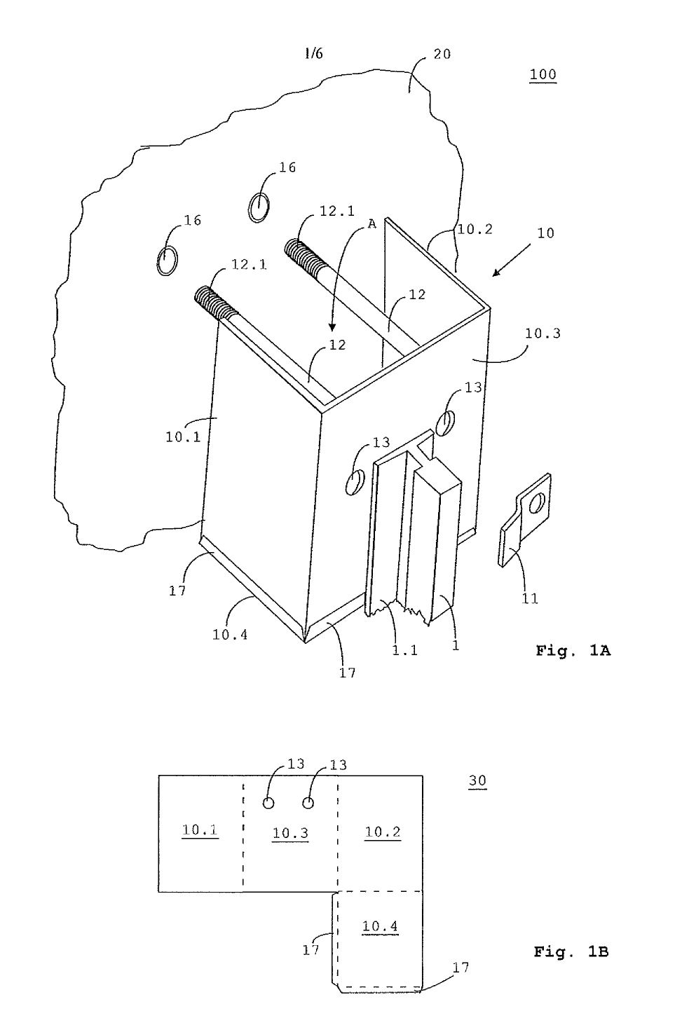

At least some of the disclosed technologies are suitable for fastening T-shaped guide rails 1 parallel to a shaft wall 20 of an elevator shaft, as indicated in FIG. 1A. Only a short section of such a guide rail 1 is shown in FIG. 1A.

Details of a first fastening device 100 for use in an elevator installation are shown in FIG. 1A. A region of the shaft wall 20 is shown in FIG. 1A. The guide rail 1 is so arranged and fastened that it extends perpendicularly in the elevator shaft parallel to the shaft wall 20. The guide rail 1 is fastened to a middle wall 10.3 of a shuttering element 10 by at least one fastening device 100 with two rail clamps 11. Of the rail clamps 11, only one is shown here. The rail clamps 11 engage around vertical sections 1.1 of the base of the guide rail 1.

An assembly set 200 (see, e.g., FIG. 3) can be specifically designed for setting up fastening device 100 on site (in situ) in an elevator installation. The assembly set 200 or the fastening device 100 comprises, as already mentioned, rail clamps 11 in order to be able to fasten the guide rail 1 to the fastening device 100. In addition, the fastening device 100 comprises, in the form of an embodiment shown in FIG. 1A, a shuttering element 10. The shuttering element 10 has a first side wall 10.1, an oppositely disposed second side wall 10.2 and a middle wall 10.3 with a vertical fastening surface. The vertical fastening surface of the middle wall 10.3 is constructed to be as flat as possible, so that the base of the guide rail 1 rests flatly there.

The mentioned walls 10.1, 10.2 and 10.3 are so arranged and connected together that in plan view they form a U-shape or V-shape. Depending on the respective form of embodiment the side walls 10.1 and 10.2 run parallel to one another. However, these side walls 10.1 and 10.2 can also be set to be slightly inclined inwardly or outwardly.

The shuttering element 10 has in the lower region a base plate 10.4 which can be seen in FIG. 1A only as an indication. The base plate 10.4 can be bent or formed from the same sheet metal body as the mentioned walls 10.1, 10.2 and 10.3 or it can be placed as a separate element against the shuttering element 10.

Overall, the shuttering element 10 in the mounted state forms together with a region of the shaft wall 20 a receiving region A which has a trough-like or tub-like shape which is upwardly open.

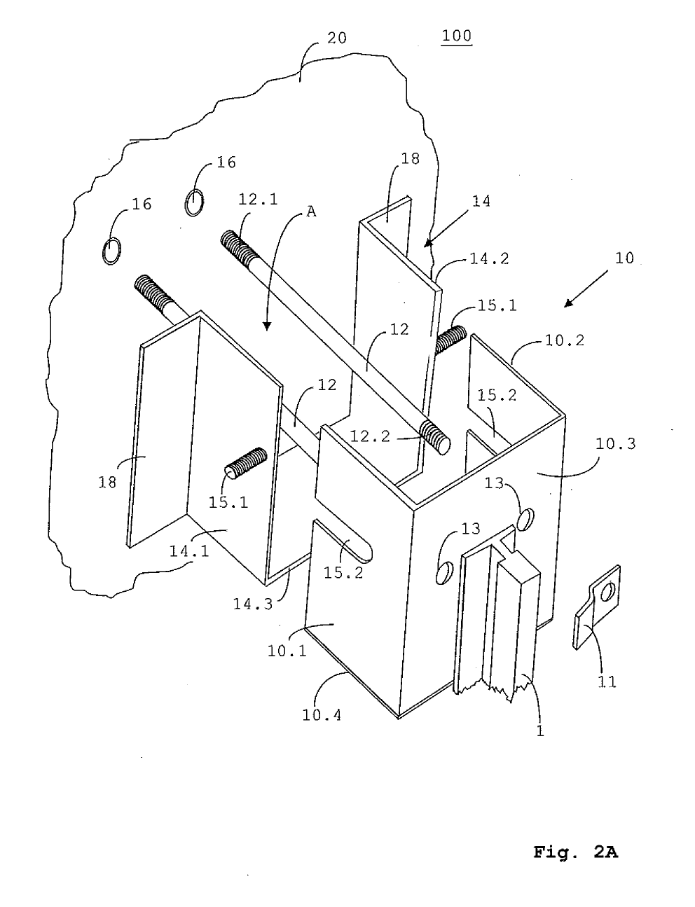

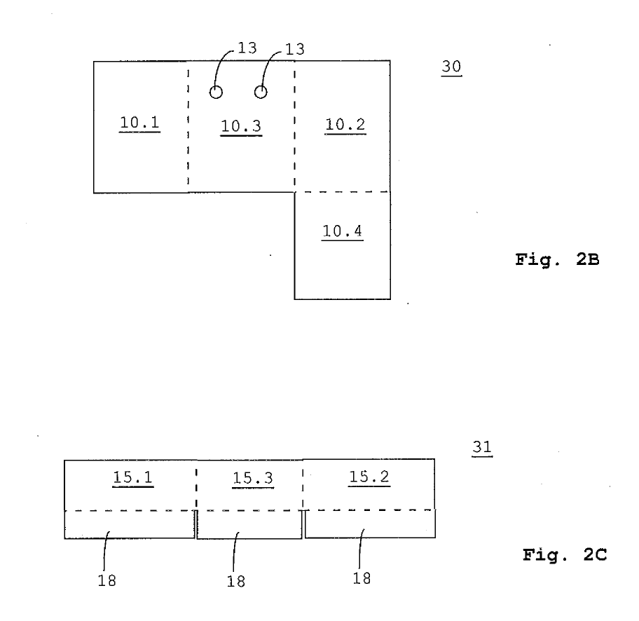

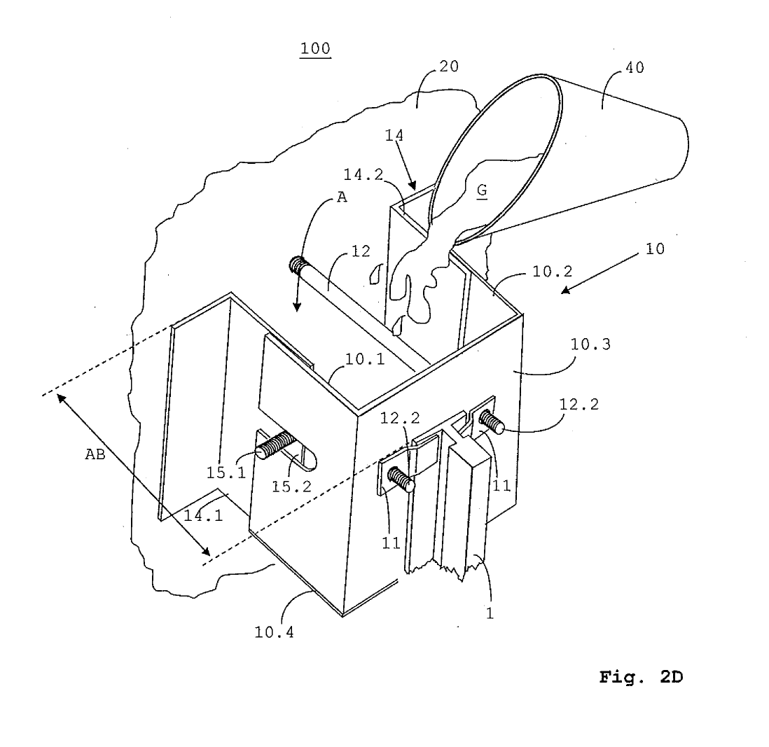

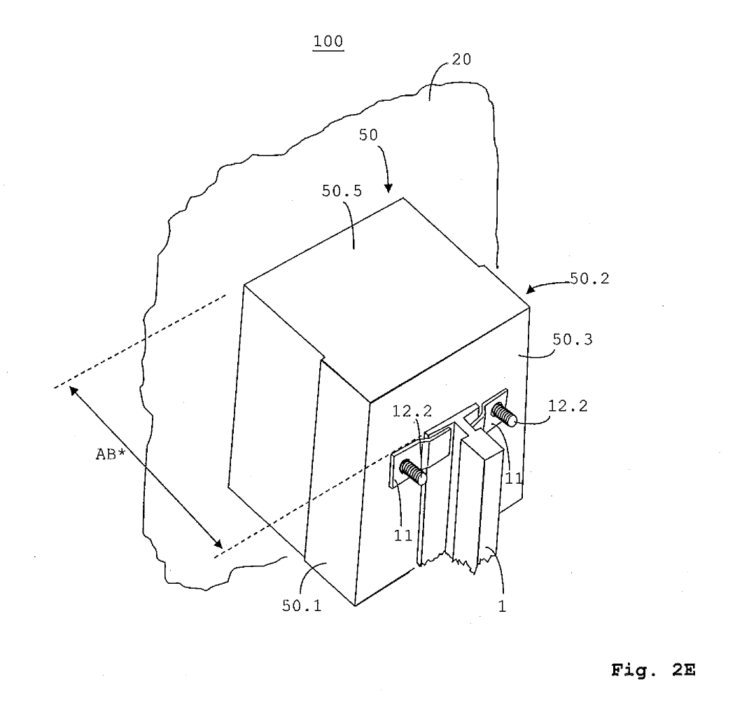

Provided at the middle wall 10.3 are at least two holes 13 in order to be able to fasten the shuttering element 10 to the shaft wall 20 by means of two fastening tie bolts 12. Threaded rods or long screws can be used as fastening tie bolts 12. Each fastening tie bolt 12 is designed at its first (front) extremal end for passage through a hole 13 of the middle wall 10.3. The second extremal end, which is opposite the first extremal end, is designed for fastening at or in the shaft wall 20. If dowels were inserted in dowel holes 16 in the shaft wall then the fastening tie bolts 12 can, for example, have a corresponding thread 12.1. A thread 12.2 can also be formed at the first extremal end (see, for example, FIG. 2A) in order to be able to screw on, for example, a nut (not shown).

The shuttering element 10 can be made from a sheet metal body 30 by bending and/or deep-drawing. A corresponding sheet metal body 30 is illustrated in FIG. 1B.

The entire shuttering element 10 can be made from a metal sheet by bending and/or deep-drawing. Respective shuttering elements 10 are shown in FIGS. 1A, 2A and 2D, which were produced by punching a metal sheet and by bending a punched sheet metal body 30. Such a sheet metal body 30 after the punching and before the bending is shown in FIG. 1B. This is a purely schematic illustration which is not to scale. The bending edges are illustrated in FIG. 1B by dashed lines. Straps 17, which after bending over bear against the walls 10.1 and 10.3, can be provided at the base plate 10.4, which is here a fixed component of the sheet metal body 30.

The assembly set 200 further comprises a minimum quantity of a hardenable casting material G, which is of such a size in terms of quantity or volume that at least a part of the receiving region A in the mounted state can be filled with the casting material G. Details with respect thereto are evident from, for example, FIG. 2D.

A casting material of cement or cement base can be used as casting material G in at least some embodiments. In some embodiments, a cement casting material G is mixed with synthetic material components so as to help ensure more rapid hardening and a greater degree of stability.

The synthetic material component can be selected such that there is acoustic decoupling of vibrations of the guide rail 1 and the shaft wall 20.

In some embodiments the assembly set 200 also comprises, additionally to the shuttering element 10, an insert element 14. Details with respect thereto can be inferred from FIGS. 2A and 2B. The insert element 14 comprises a first side wall 14.1, an oppositely disposed second side wall 14.2 and a base plate 14.3, which in side view (in direction towards the shaft wall 20) form a U-shape. The dimensions of the insert element 14 and the shuttering element 10 can be so selected that the two can be joined together during assembly, as can be seen in FIG. 2D. All other statements which were made with respect to the shuttering element in connection with FIGS. 1A and 1B also apply to the form of embodiment according to FIGS. 2A and 2B.

The form of embodiment according to FIGS. 2A and 2B can be distinguished by the following optional features. Threaded pins 15.1 or screws are so fastened to the side walls 14.1 and 14.2 that they point perpendicularly outwardly. Corresponding slots or recesses 15.2 are provided at the shuttering element 10 so that the shuttering element can be pushed onto the insert element 14. For the purpose of fastening, nuts (not shown) can be screwed onto the threaded pins 15.1 or screws and tightened. Through the formation of slots or recesses 15.2 it is possible to displace the shuttering element 10 relative to the insert element 14. Through the corresponding complementary fastening means 15.1, 15.2, which are designed for displaceable fastening of the shuttering element 10 at the insert element 14, it is possible to so displace the shuttering element that a desired spacing AB between the shaft wall 20 and the base of the guide rail 1 results.

The insert element 14 can have straps or a collar 18 on the shaft wall side, as is shown in FIGS. 2A and 2B. These straps are or the collar 18 is, however, optional. They can be used when the casting material G of the assembly set 200 has particularly low viscosity.

In FIG. 2D the elements of the assembly set 200 are preassembled. Nuts or other fastening means employed for the fastening or screw-connecting are, however, not shown, so as not to overload the illustration. The insert element 14 sits flatly on the shaft wall 20. The shuttering element 10 was pushed onto the insert element 14 and can be fastened by complementary fastening means 15.1, 15.2 (for example, a screw/nut combination). The guide rail 1 can be fastened to the middle wall 10.3 by screwing of the fastening tie bolts 12 into holes 16 of the shaft wall 20 and by fitting rail clamps 11 and screwing nuts (not shown) onto the threads 12.2 of the fastening tie bolts 12. The entire fastening equipment 100 can be tightened by the fastening tie bolts 12 against the shaft wall 20 and held stably in position there. Through fine adjustment of the individual parts the spacing AB can be precisely set and the vertical alignment of the guide rail 1 predetermined.

A possible finishing of the fastening equipment 100 now follows in a further step on site. For this purpose, as already mentioned, casting material G is poured into the recess A. In FIG. 2D this process is indicated by a can 40, which is filled with flowable casting material G.

After hardening of the casting material G the shuttering element 10 and/or the insert element 14 can remain on site and in position, i.e. these elements 10, 14 are not demounted. However, it is also possible to detach and remove these elements 10, 14. In this case they can be reused.

A situation after removal of the shuttering element 10 and the insert element 14 is shown in FIG. 2E. A so-called fastening block 50 with a first side wall 50.1, an opposite side wall 50.2 (not visible), a middle wall 50.3, a lower side 50.4 (not visible) and an upper side 50.5 remains. Due to the fact that now the middle wall 10.3 of the shuttering element 10 has been removed, the spacing AB has reduced to a spacing AB*. The reduction in the spacing approximately corresponds with the thickness of the middle wall 10.3. Either this change in the spacing was taken into consideration at the outset in the construction of the fastening equipment 100 or the original spacing AB is produced again in that a washer or plate (not shown) is inserted between the base of the guide rail 1 and the middle wall 50.3 of the fastening block 50. The thickness of the washer or plate approximately corresponds with the thickness of the middle wall 10.3. The two fastening tie bolts 12 are now firmly anchored in the shaft wall 20 and surrounded by the hardened casting material G. Only the threaded sections 12.2 still protrude at the front side. The rail clamps 11 can now be fitted here and fastened by nuts (not shown).

The entire shuttering element 10 can be, as mentioned, made of metal sheet by bending and/or deep-drawing. Such a sheet metal plate 30 body is shown in FIG. 2B after punching and before bending. This is a purely schematic illustration which is not to scale. The bending edges are illustrated in FIG. 2B by dashed lines. No straps 17 are provided at the base plate 10.4, which here is a fixed component of the sheet metal body 30. However, straps 17 can, according to FIG. 1B, be used in order to achieve better sealing for the filling up with low viscosity casting material G.

The entire insert element 14 can be, as mentioned, made of a metal sheet by bending and/or deep-drawing. Such a sheet metal body 31 is shown in FIG. 20 after punching and before bending. This is a purely schematic illustration which is not to scale. The bending edges are indicated in FIG. 2C by dashed lines. Straps 18, which are to later bear against the shaft wall 20, can be provided at all three elements 15.1, 15.2, 15.3 of the sheet metal body 31. A higher level of sealing for the filling with low viscosity casting material G can thereby be achieved. However, the straps 18 are optional.

Overall, a very robust and permanent fastening of the guide rail 1 to the shaft wall 20 can result.

Several fastening blocks 50 of that kind can be used along the guide rail 1. A vertical spacing of 1 to 4 meters between two fastening blocks 50 has proved satisfactory.

Due to the fact that the shuttering element 10 and the insert element 14 are upwardly open they can be removed without problems in downward direction after hardening of the casting material G.

In at least some embodiments a release medium can be used or introduced into the recess A in order to make possible better separation of the elements 10 and 14 from the fastening block 50 after hardening of the casting material G.

The components of a first assembly set 200 are shown in FIG. 3 in schematic form, which is not to scale. The assembly set 200 here comprises a shuttering element 10, two rail clamps 11, two fastening tie bolts 12, two matching nuts 19 and a drum 41 with casting material G.

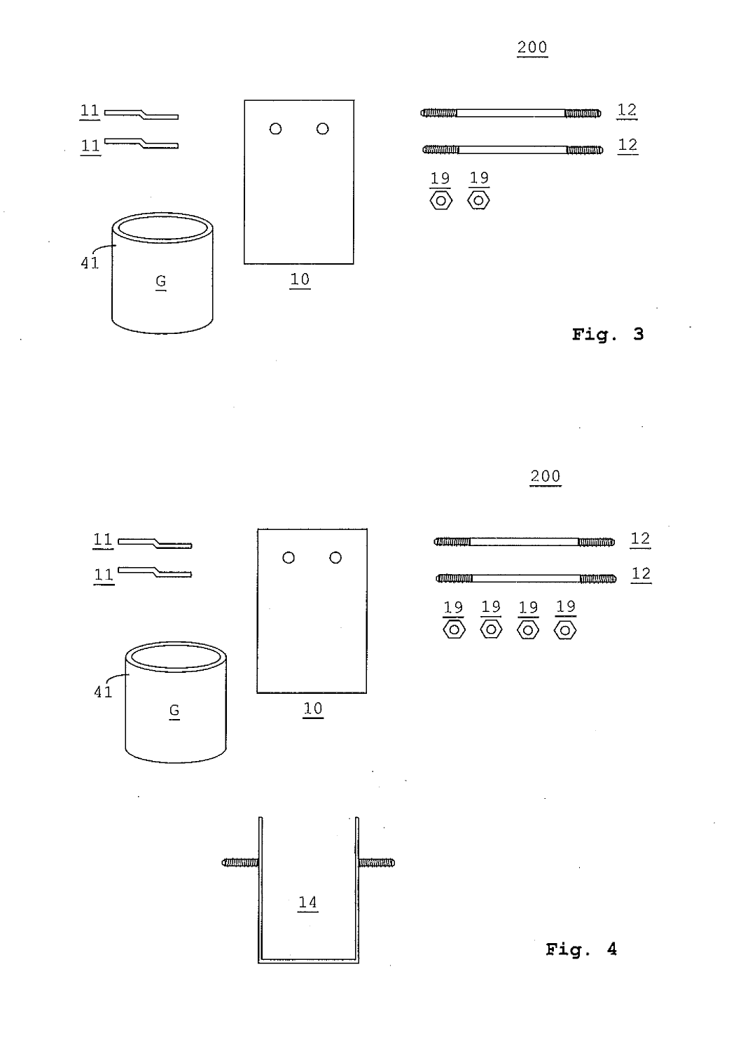

The components of a second assembly set 200 are shown in FIG. 4 in schematic form, which is not to scale. The assembly set 200 here comprises a shuttering element 10, an insert element 14 (without straps or collar 18), two rail clamps 11, two fastening tie bolts 12, four matching nuts 19 and a drum 41 with casting material G.

In at least some embodiments the fastening block 50 can ensure a uniform and robust distribution of force. As a result, the entire elevator installation can be more stable and the elevator cage or the counterweight can run more smoothly.

Mounting can be simple and free of problems. The cost for production of the fastening blocks 50 can be smaller than in the case of previous solutions. This can apply also to solutions which are made of sheet metal and which can be reused multiple times, as described.

For preference, a slot 15.2 is used at one point of the assembly set 200 so as to be able to provide compensation for tolerances on site during mounting.

In some embodiments, the rail clamps 11 are designed as slide elements, which can be fastened at any desired position of a vertical section 1.1 of the base of the guide rail 1.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator installation fastening device comprising a shuttering element, the shuttering element comprising a plurality of walls, wherein the shuttering element is configured to at least partially define a casting material receiving region when the shuttering element is mounted on an elevator shaft wall, wherein the shuttering element is further configured to be fastened to the shaft wall and to a guide rail by two or more fastening tie bolts.

2. The elevator installation fastening device of claim 1, wherein the shuttering element is made from a sheet metal body that has been bent.

3. The elevator installation fastening device of claim 1, wherein the shuttering element is made from a sheet metal body that has been deep-drawn.

4. The elevator installation fastening device of claim 1, wherein the elevator installation fastening device further comprises an insert element, the insert element comprising opposed first and second walls and comprising a base plate, and wherein the insert element and at least some of the walls of the shuttering element are configured to be joined together.

5. The elevator installation fastening device of claim 4, further comprising a fastener for joining together the insert element and at least some of the walls of the shuttering element.

6. An elevator installation comprising:
an elevator guide rail extending along at least a portion of an elevator shaft; and
an elevator installation fastening device, the device comprising a plurality of walls at least partially defining a casting material receiving region, wherein the fastening device is coupled to an elevator shaft wall by fastening tie bolts and to the elevator guide rail by the fastening tie bolts.

7. The elevator installation of claim 6, wherein at least a portion of the elevation installation fastening device is made of a sheet metal body by bending.

8. The elevator installation of claim 6, wherein at least a portion of the elevation installation fastening device is made of a sheet metal body by deep-drawing.

9. The elevator installation of claim 6, wherein the elevator installation fastening device further comprises an insert element and a shuttering element, the insert element comprising opposed first and second walls, the insert element further comprising a base plate, the shuttering element comprising a plurality of walls, and wherein the shuttering element fits at least partly around the insert element.

10. The elevator installation of claim 9, further comprising complementary fastening means for attaching the shuttering element to the insert element.

11. An elevator installation method comprising:
mounting a shuttering element on at least one elevator shaft wall, the mounting comprising fastening at least one tie bolt to the at least one elevator shaft wall through a first hole of a middle wall of the shuttering element and fastening a second tie bolt to the at least one elevator shaft wall through a second hole of the middle wall of the shuttering element, wherein the shuttering element at least partially defines a receiving region;
fastening an elevator guide rail to the middle wall of the shuttering element; and
filling at least a portion of the receiving region with one or more casing materials.

12. The elevator installation method of claim 11, further comprising coupling an insert element to the shuttering element such that the shuttering element engages at least partially around the insert element.

13. The elevator installation method of claim 11, further comprising removing at least a portion of the shuttering element after the filling at least a portion of the receiving region with the one or more casing materials.
